(19) United States
(12) Patent Application Publication
(10) Pub. No.: US 2007/0039361 A1
(43) Pub. Date: Feb. 22, 2007

(54) Lock assembly for a safe deposit box and uses thereof

(76) Inventors: Michael Hassebrock, Alpharetta, GA (US); Randall Carter, Jackson, GA (US)

Correspondence Address: Justin S. Rerko & Associates, LLC, 19836 Ellsworth Drive, Strongsville, OH, 44149, US

(21) Appl. No.: 11/299,853

(22) Filed: Dec. 12, 2005

Related U.S. Application Data
(60) Provisional application No. 60/709,331, filed on Aug. 18, 2005.

(51) Int. Cl. E05B 35/08

(52) U.S. Cl. 70/337

(57) ABSTRACT

A high security lock assembly for a safe deposit box door. The lock assembly generally includes a customer lock mechanism capable of at least five million actuation configurations, and wherein the customer lock mechanism includes a selected one of the actuation configurations; and a bolt mechanism, operatively associated with the customer lock mechanism, adapted for selectably engaging a safe deposit box to which the door is pivotally associated for locking the door relative to the safe deposit box.

### CROSS REFERENCE TO RELATED APPLICATIONS

This application claims the benefit of U.S. Provisional Patent Application Ser. No. 60/709,331, filed Aug. 18, 2005, the contents of which are hereby incorporated by reference.

### FIELD OF THE INVENTION

The present invention is directed to safe deposit boxes and lock assemblies therefor. More particularly, the present invention is directed to a high security lock assembly for a safe deposit box that restricts access to the contents of the safe deposit box to only authorized individuals.

### BACKGROUND OF THE INVENTION

Safe deposit boxes are a frequently employed means for securing articles. As known, banks, hotels and similar institutions typically maintain a vault or similar structure that houses a plurality (typically hundreds) of safe deposit boxes, each of which is rented to a particular customer and accessible only to that particular customer. Such access is often mediated by a dual key locking assembly associated with a safe deposit box door. The dual key locking assembly typically includes a guard key interface (e.g., lock) for receiving a bank official key and a customer key interface (e.g., lock) for receiving a customer-issued key. The guard key interface cooperates with the customer key interface to permit access to the contents of the safe deposit box only upon simultaneous actuation of both key interfaces.

As known, the guard key interface is typically individual box non-specific. In other words, the guard key interface of every safe deposit box within a collection of safe deposit boxes is actuable by a single bank official key. Requiring the actuation of the guard key interface provides a security measure by enabling bank official oversight of a customer's access of the customer's safe deposit box.

As also known, the customer key interface is typically individual box specific. In other words, a customer issued key will only actuate the particular safe deposit box to which the customer issued key corresponds, thereby permitting the customer to access only the safe deposit box that the customer has rented, and also thereby prohibiting the customer from accessing any safe deposit box that the customer has not rented.

### SUMMARY OF THE INVENTION

In accordance with an example aspect, the present invention is directed to a lock assembly for a safe deposit box door. The assembly generally includes a customer lock mechanism capable of at least five million actuation configurations, and wherein the customer lock mechanism includes a selected one of the actuation configurations; and a bolt mechanism, operatively associated with the customer lock mechanism, adapted for selectably engaging a safe deposit box to which the door is pivotally associated for locking the door relative to the safe deposit box.

In accordance with another example aspect, the present invention is directed to a safe deposit box for securely storing articles therein. The safe deposit box generally includes a housing adapted for receiving articles into an inner cavity thereof; a door pivotally associated with the housing; and a lock assembly associated with the door and adapted for selectably locking the door relative to the housing. The lock assembly generally includes a customer lock mechanism capable of at least five million actuation configurations, and wherein the customer lock mechanism includes a selected one of the actuation configurations; and a bolt mechanism, operatively associated with the customer lock mechanism, adapted for selectably engaging the housing.

In accordance with yet another example aspect, the present invention is directed to a safe deposit box for securely storing articles therein. The safe deposit box generally includes a housing -adapted for receiving articles into an inner cavity thereof; a door pivotally associated with the housing; and a lock assembly associated with the door and adapted for selectably locking the door relative to the housing. The lock assembly generally includes a customer lock mechanism capable of at least twenty million actuation configurations, and wherein the customer lock mechanism includes a selected one of the actuation configurations; a bolt mechanism, operatively associated with the customer lock mechanism, adapted for selectably engaging the housing; and a guard lock mechanism.

### BRIEF DESCRIPTION OF DRAWINGS

These and other features and a more thorough understanding of the present invention may be achieved by referring to the following description and claims, taken in conjunction with the accompanying drawings, wherein:

FIG. 1 is a perspective view of an example safe deposit box door incorporating an example lock assembly according to the present invention;

FIG. 2 is a perspective view of an example collection of safe deposit boxes of FIG. 1;

FIG. 3 is a top perspective view of the example lock assembly of FIGS. 1 and 2;

FIG. 4 is a another perspective view of the example lock assembly of FIG. 3;

FIG. 5 is a top perspective view of the example lock assembly of FIGS. 3 and 4, wherein a support plate thereof is removed to illustrate assembly inner contents;

FIG. 6 is a perspective view of an example support plate of the lock assembly of FIGS. 1-4;

FIG. 7 is a top plan view of the lock assembly of FIG. 5, wherein a restriction means thereof is in a closed configuration;

FIG. 8 is a top plan view of the lock assembly of FIG. 7, wherein a restriction means thereof is in an open configuration;

FIG. 9 is a perspective view of an example customer lock of the lock assembly of the preceding figures; and

FIG. 10 is a side plan view of the example customer lock of FIG. 9.

### DETAILED DISCUSSION OF EXAMPLE EMBODIMENTS

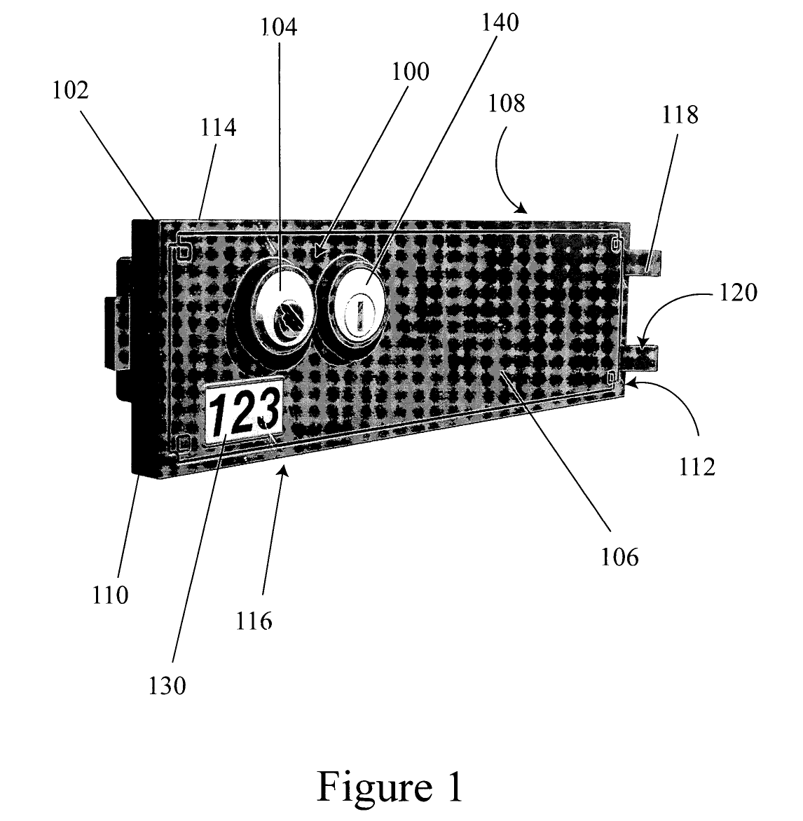

Disclosed according to the present invention is a lock assembly 100 for a safe deposit box and various uses thereof. The lock assembly 100 is generally configured to be associated with a door 102 (FIG. 1) of a safe deposit box and provide a means for selectably locking the door 102 and thereby restricting access to contents of the safe deposit box.

As will be more fully explained hereinafter, the lock assembly 100 is preferably configured as a high security measure that is capable of being configured to feature any of a myriad of actuation configurations. As known to one of ordinary skill in the art, a lock assembly actuation configuration is typically defined by a precise three dimensional profile that is adapted to receive therein a key (typically through a keyway). In customary operation, the lock assembly is first configured to adopt a selected actuation configuration and then the key (especially a blade thereof) is configured to feature a three dimensional profile complementary to the actuation configuration. Accordingly, upon association of a lock assembly and a key having a profile complementary to the lock assembly actuation configuration, the lock assembly may suitably be actuated (e.g., opened, locked, etc.).

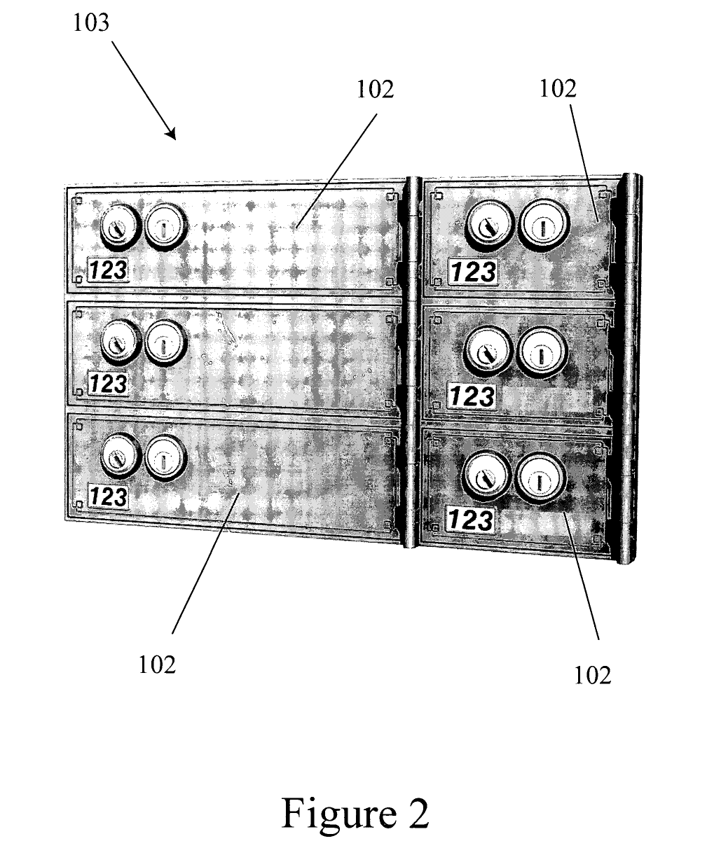

In a preferred embodiment and as will be more fully described hereinafter, the lock assembly 100 is adapted to permit at least one million distinct actuation configurations. Conventional lock assemblies for conventional safe deposit boxes are generally adapted to permit a significantly reduced number of actuation configurations, typically on the order of about one hundred thousand to about three hundred thousand usable actuation configurations. Additionally, conventional collections 103 (FIG. 2) of safe deposit boxes (such as those featured at a banking institution, a lodging facility (e.g., hotel) and the like) may feature a plurality of safe deposit boxes. Accordingly, as the number of safe deposit boxes present in such a collection 103 increases, so too increases the possibility that an issued customer key may simultaneously actuate several safe deposit boxes, thereby creating the potential for unauthorized safe deposit box access. Therefore, the lock assembly of the present invention suitably overcomes the potential for unauthorized access by enabling a collection 103 of safe deposit boxes to feature an aggregate number of distinct lock assembly actuation configurations that greatly exceeds the number of safe deposit boxes present in the collection.

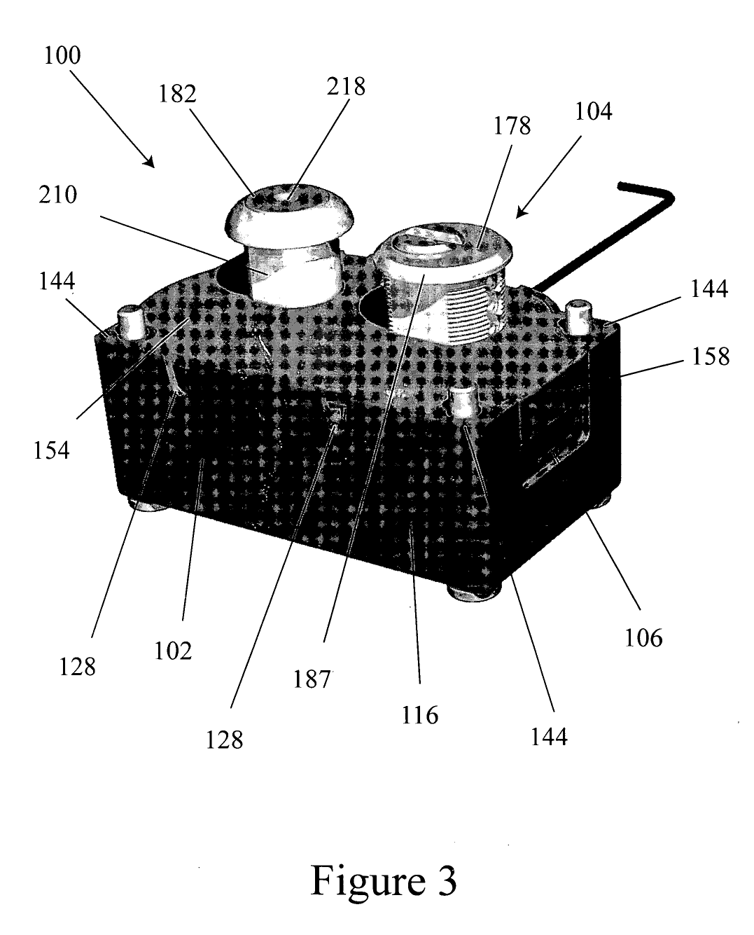

Turning now to FIG. 3, illustrated is a preferred, yet exemplary, embodiment of a lock assembly 100 according to the present invention. The lock assembly 100 generally includes a lock assembly housing 101, a customer interface 104, and a locking mechanism 106. As will be more fully explained hereinafter, the lock assembly housing 101 generally provides a housing within and/or to which the various components of the lock assembly 100 are interassociated. The customer interface 104 generally provides a means by which actuable access to the lock assembly 100 is restricted to only authorized individuals (e.g., a customer to whom lock assembly 100 (and, by extension, safe deposit box) has been assigned and/or generally rented). Such actuable access suitably provides a means for selectably locking and opening the safe deposit box. The locking mechanism 106 is preferably operably associated with the customer interface 104 and provides a structure (e.g., a bolt mechanism, a cam mechanism, etc.) that is adapted to releasably engage complementary structure of the safe deposit box to lock and unlock the door 102 relative to the safe deposit box.

Turning now to FIGS. 3-8 and a discussion of the lock assembly housing 102, the housing 101 preferably provides a number of functions relative to the lock assembly 100 of the present invention. In one aspect, the housing 101 provides a casing-like member that generally houses and/or provides an association substrate for the various components of the lock assembly 100 (e.g., the customer interface 104, the locking mechanism 106, etc.). In another aspect, the housing 101 also preferably defines a core structure that is associable with a conventional safe deposit box door 101. More specifically, the housing 101 generally defines an interfacing structure that permits the components of the locking assembly 100 to be operably associated with and the door 102. Further thereto, the housing 101 is adapted to be associated generally with any conventional safe deposit box door, and thereby provides a means by which any conventional safe deposit box door may be retrofit with the lock assembly 100 of the present invention.

With best reference to FIGS. 3, 5 and 6, the housing 102 preferably includes a casing 108 and a support plate 110. The casing 108 is preferably defined as a generally prismatically rectangular member, having an inner cavity 122 in which is disposed various lock assembly 100 elements, as will be more fully described hereinafter. Even more preferably, the casing 108 is open along one of its faces (e.g., the casing 108 is preferably defined by five, rather than six, faces). In this embodiment, the support plate 110 generally removably interfaces with the casing 108 and, when so interfaced, defines the sixth face of the casing 108. As will also be more fully explained hereinafter, the support plate 110 generally provides a substrate against which various components of the customer interface 104 are associated.

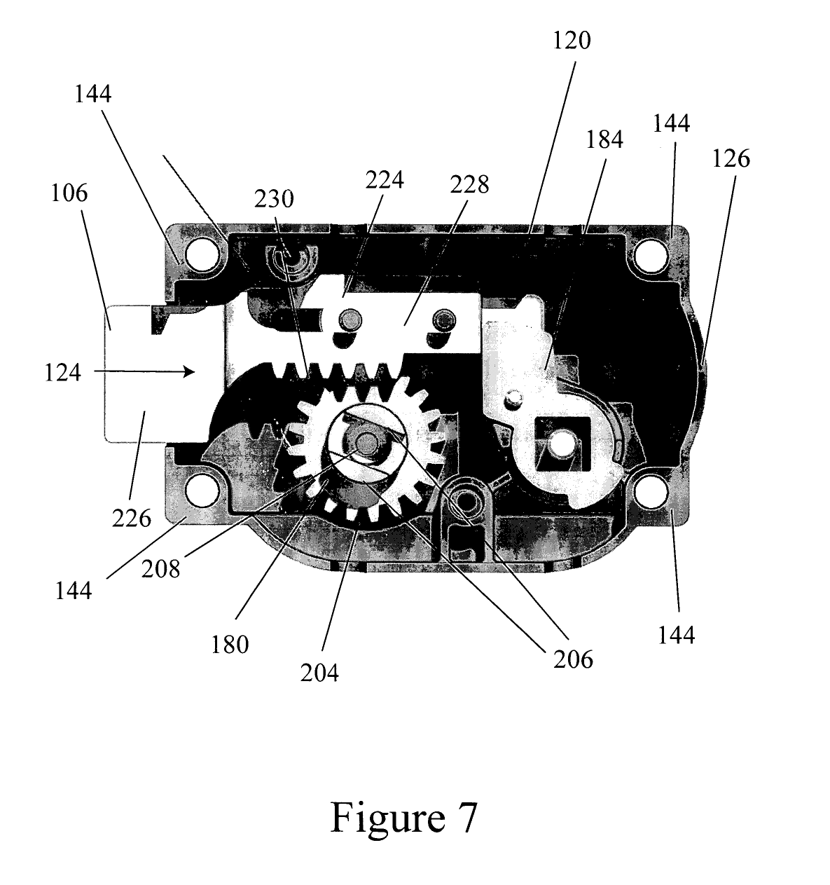

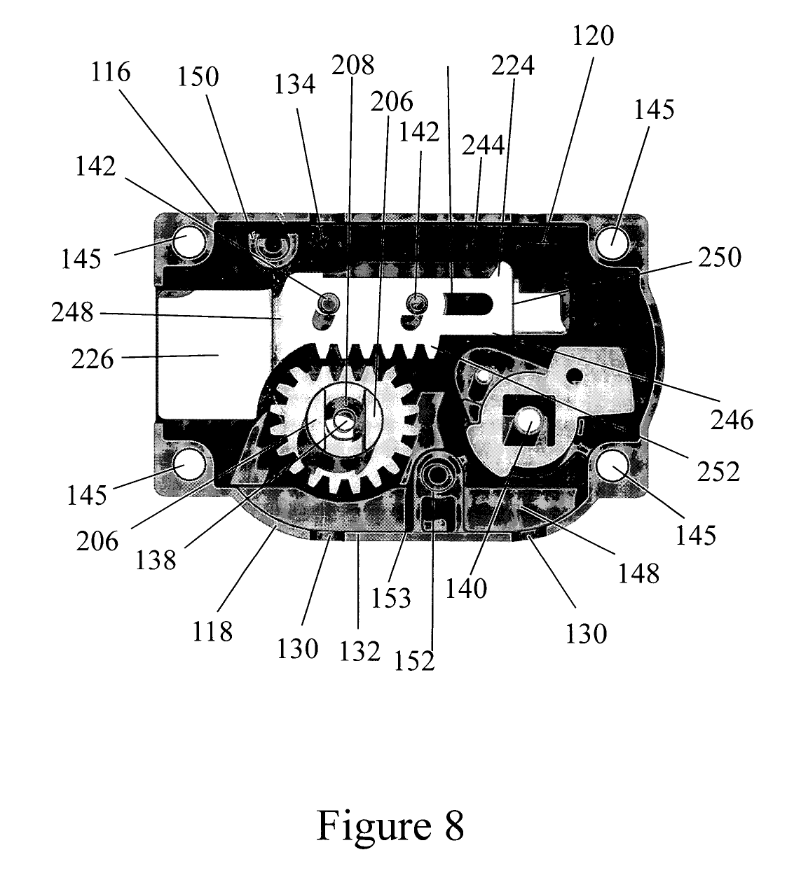

Turning now to FIGS. 3, 5 and 7, the casing 108 is preferably defined by left and right spaced apart side walls 112, 114, a rear wall 116, a front wall 118, and a base wall 120. The left and right side walls 112, 114 generally define left and right faces of the casing 108, and are preferably coplanar and spaced apart from each other so as to define therebetween a portion of the inner cavity 122. The left wall 112 preferably includes an aperture-like opening 124 (FIGS. 7 and 8) through which the locking mechanism 106 may suitably pass for selectable engagement with the safe deposit box, as will be more fully explained hereinafter. Further, the right side wall 114 generally includes an outwardly bowed portion 126, which generally provides a space for rotation of various customer interface 104 elements, as will also be more fully explained hereinafter.

With best reference to FIG. 3, the casing 108 rear wall 116 preferably defines a rear face of the lock assembly 100 and is preferably disposed so that its vertical terminal edges generally abut rear vertical edges of the left and right side walls 112, 114. In a preferred embodiment, the rear wall 116 generally includes at least one scallop-like arcuate portion 128. As will be more fully explained hereinafter, the arcuate portion 128 generally provides a means for gaining access to the inner cavity 122 when the lock assembly 100 is in a fully assembled state (e.g., the support plate 110 is associated with the casing 108). The arcuate portion 128 is suitably defined by a partially open portion that extends along an upper edge of the rear wall 116. The partially open arcuate portion 128 is suitably closed (i.e., its partially open portion is completed) when the support plate 110 is associated with the casing 108.

Turning now to FIG. 8, the casing 108 preferably also includes the front wall 118. The front wall 118 is preferably oriented in a spaced apart relation to the rear wall 116, and is generally coplanar therewith. The front wall 118 generally cooperates with the rear wall 116 and side walls 112, 114 to define therebetween the inner cavity 122. Further, the front wall 118 is generally perpendicular to the side walls 112, 114, and abuts front vertical edge portions of the side walls 112, 114 along its terminal vertical edges.

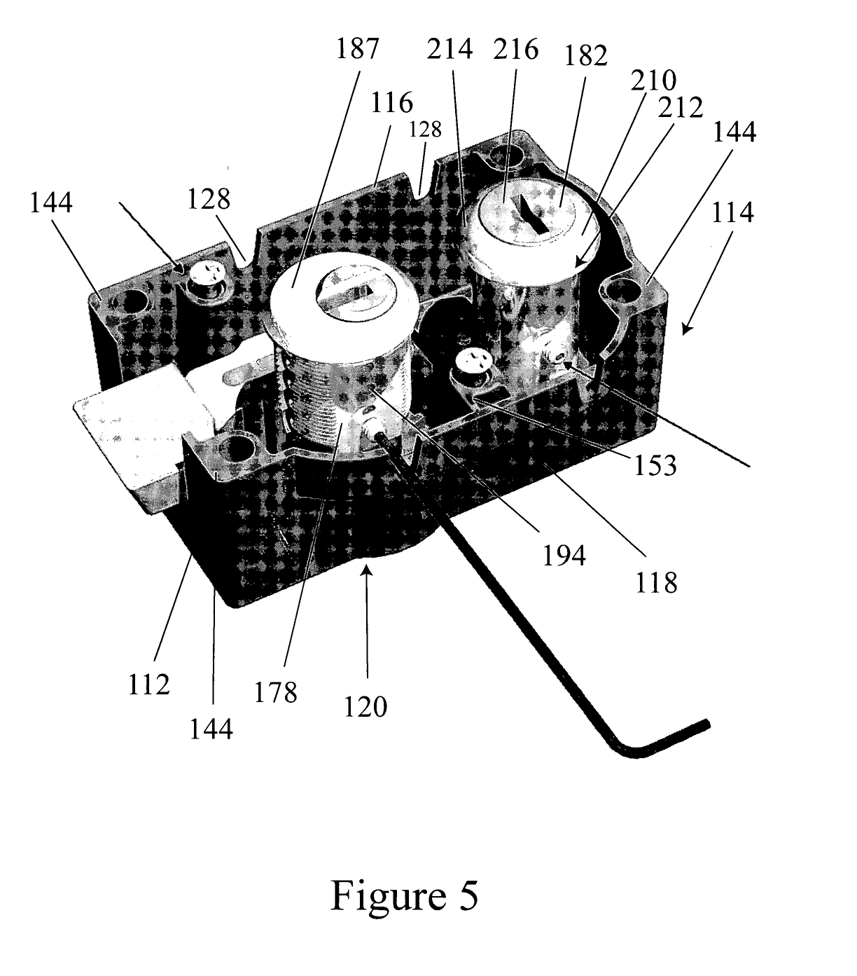

With continued reference to FIG. 8 and turning also to FIG. 5, the front wall 118 preferably includes an outwardly bowed portion 132. As will be more fully explained hereinafter, the bowed portion 132 generally provides a selectably expanded portion of the inner cavity 122 that accommodates the presence of various customer interface 104 elements.

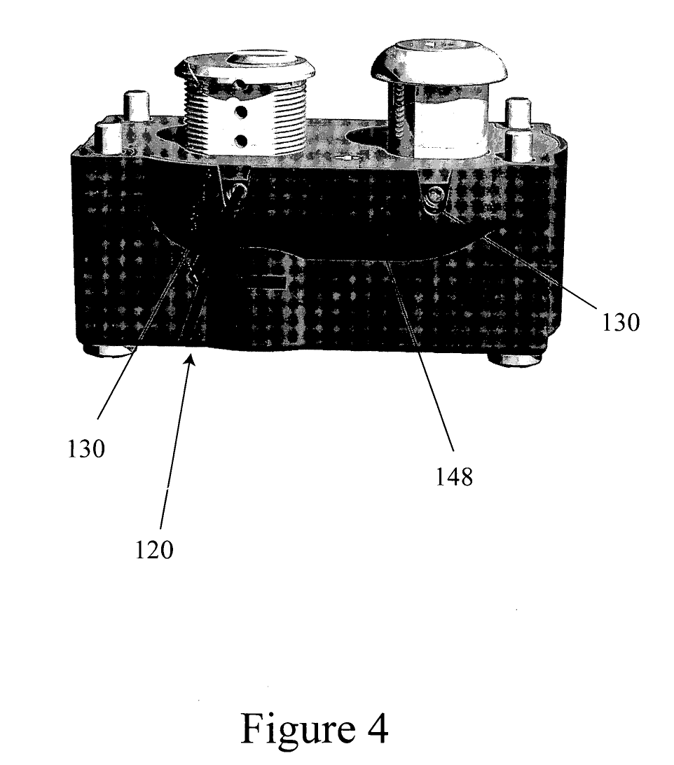

With best reference to FIGS. 4, 5 and 8, the bowed portion 132 preferably extends along a substantial portion of the front wall 118 lateral face. Even more preferably, and as best shown in FIG. 4, the bowed portion 132 suitably includes a shoulder 148 that extends generally perpendicularly outward from the front wall 118. In that regard, the bowed portion 132 is preferably defined by an arcuate and generally rectangular member, opposite lateral edges of which terminate into the front wall 118, and a bottom edge of which terminates into a front edge of the shoulder 148 (preferably at a right angle thereto). As will be more fully explained hereinafter, the shoulder 148 preferably provides a substrate against which the support plate 110, or a portion thereof, rests.

Similar to the rear wall 116, the front wall 118 suitably also includes one or more scallop-like arcuate portion 130 (FIGS. 4 and 8). As will be more fully explained hereinafter, the arcuate portion 130 generally provides a means for permitting access to the inner cavity 122 when the lock assembly 100 is in a fully assembled state (e.g., the support plate 110 is associated with the casing 108). The arcuate portion 130 is suitably defined by a partially open portion that extends along an upper edge of the front wall 118, even more preferably the bowed portion 132 thereof. The partially open arcuate portion 130 is suitably closed (i.e., its partially open portion is completed) when the support plate 110 is associated with the casing 108.

Turning now to FIGS. 4, 7 and 8, the casing 108 generally also includes the base wall 120. The base wall 120 generally provides a structural base from which the casing 108 front wall 118, rear wall 116, left side wall 112, and right side wall 114 extend. More specifically, the walls 118, 116, 112, 114 preferably extend generally perpendicularly from edge portions of the base wall 120. As will be more fully explained hereinafter, the base wall 120, especially a top face 134 thereof, generally provides a substrate to which various components of the lock assembly 100, particularly the customer interface 104 and the locking mechanism 106, are associated. Further, the base wall 120 generally defines a component of the lock assembly 100 that is oriented opposite and generally spaced apart from the safe deposit box door 102 when the assembly 100 is associated with the door 102, as will also be more fully explained hereinafter.

With further reference to the base wall's 120 substrate function, the base wall 120 suitably includes a plurality of projections for such association. In one aspect and with reference to FIG. 8, the base wall 120 includes a first projection 138 and a second projection 140 that generally operate to associate various components of the customer interface 104 to the base wall 120. The base wall 120 may suitably also include one or more projections 142 that are adapted to associate the locking mechanism 106 to the base wall 120. Even more preferably, the projections 142 are adapted to also permit the locking mechanism 106 to be slidably disposed relative to the base wall 120. Various aspects of the projections 138, 140, 142 will be more fully described hereinafter.

Turning now to FIGS. 3, 5 and 7, the casing 108 generally also includes a plurality of boss-like corner portions 144, each of which is preferably disposed at each of the corners of the casing 108. For example, one of the corner portions 144 is preferably vertically disposed at the interface of the left side wall 112 and the front wall 118, while a second corner portion 144 is preferably vertically disposed at the interface of the left side wall 112 and the rear wall 116, etc. The corner portions 144 preferably each feature a bore 145 (FIG. 8) extending vertically therethrough, each of which bores 145 are suitably adapted to secure a dowel-like pin 146 therein (FIG. 3). As will be more fully explained hereinafter, the pins 146 are preferably disposed so as to extend beyond the corner portions 144 and away from the casing 108 base wall 120. As such, the pins 146 are preferably adapted to interface with complementary receiving structure on a rear face of the safe deposit box door 102. Accordingly, the pins 146 suitably provide an interface between the casing 108 and the door 102 that increases the stability of the casing 108 relative to the door 102, as will also be more fully explained hereinafter.

The casing 108 may suitably also include one or more support bosses 150, 152 that are adapted to interact with and provide a support surface for the support plate 110. With best reference to FIGS. 3, 5 and 8, the support boss 150 is preferably disposed in general abutting relationship to the casing 108 rear wall 116, and preferably along a position that is in general proximity to the left side wall 112. The boss 150 preferably includes a bore therethrough that extends generally parallel to the bores 145 of the corner portions 144. The casing 108 may suitably also include another support boss 152 that is disposed opposite the boss 150 and in general abutting relationship to the front wall 118. As previously mentioned, the front wall 118 suitably includes the bowed portion 132 that preferably does not extend along the entire vertical dimension of the front wall 118. Accordingly, the support boss 152 is preferably disposed in abutting contact with the front wall 118 along a lower portion thereof that is not bowed, and then extends upward so as to be slightly spaced apart from the bowed portion 132. Further thereto, an upper portion of the support boss 152 may suitably interface with the bowed portion 130 through one or more reinforcing ribs 153 (FIGS. 5 and 8).

Turning now to FIG. 3, the support bosses 150, 152 generally provide a surface onto which the support plate 110 may suitably be supported and positioned. The support bosses 150, 152 preferably also provide an anchoring structure to which the support plate 110 may suitably be secured. As previously mentioned, the support bosses 150, 152 preferably include the bores 145 therethrough. The support plate 110 preferably also includes one or more bores that are positioned to communicate with the support bosses' 150, 152 bores 145. Accordingly, a fastener 155 may suitably be disposed through the support plate 110 bores and into engagement with the support bosses 150, 152 to releasably or otherwise secure the support plate 110 to the casing 108.

The locking assembly 100 housing 101 preferably also includes the support plate 110. As previously mentioned, the support plate 110 preferably defines a sixth face of the casing 108 (so as to complete the rectangular prism configuration thereof). The support plate 110 suitably also provides a removable access means that enables selectable access to the inner cavity 122 of the housing 101. In yet another aspect and as will be more fully explained hereinafter, the support plate 110 suitably includes various structure that generally provides an anchoring structure to which various components of the customer interface 104 may suitably be secured.

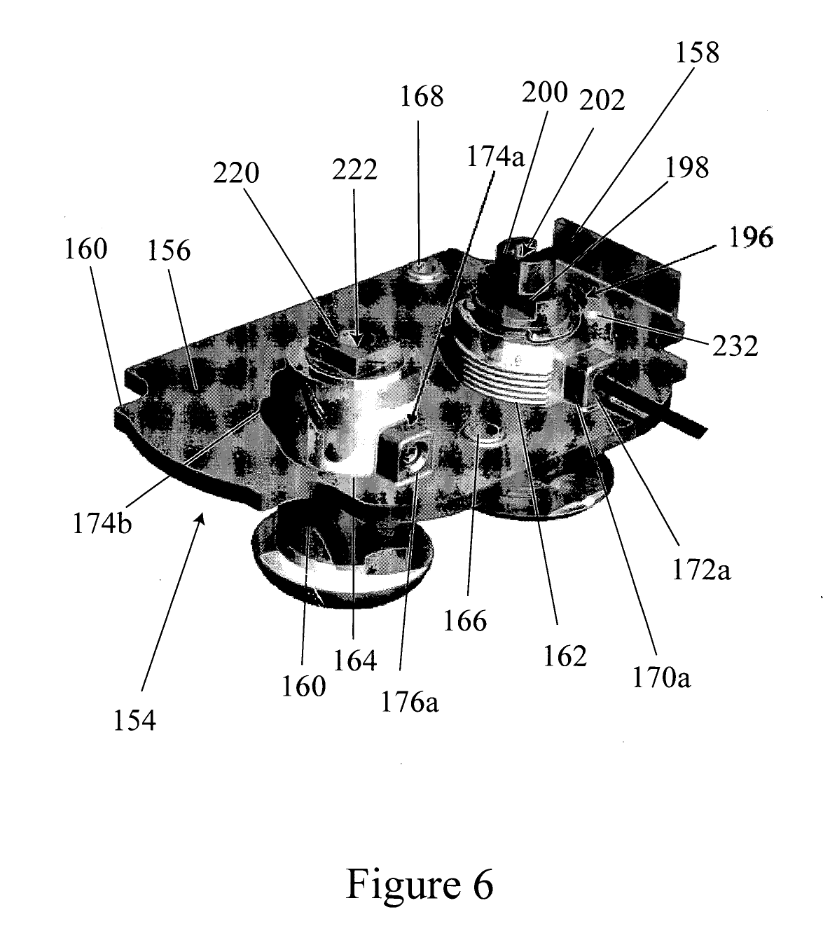

Turning now to FIG. 6, an exemplary support plate 110 according to the present invention generally includes a top face 154, a bottom face 156, and a flange 158. The top face 154 is a generally planar member and suitably faces away from the inner cavity 122 when the plate 110 is associated with the casing 108. The bottom face 156 is also a generally planar member coplanar with the top face 154, and generally faces the inner cavity 110 when the plate 110 is associated with the casing 108.

The support plate 110 suitably also includes the flange 158. In a preferred embodiment, the flange 158 is generally adapted to define a portion of the casing 108 left side wall 112. As previously mentioned and as best shown in FIG. 7, the left side wall 112 preferably includes the aperture 124 that permits the locking mechanism 106 to selectably extend beyond the housing 101. The aperture 124 is generally defined by a gap in the side wall 112 that preferably extends along the entire vertical dimension thereof. Accordingly, the support plate 110 flange 158 preferably extends into the aperture 124 so as to reduce the open dimensions thereof. In that regard, the flange 158 preferably extends generally perpendicularly from an edge of the support plate 110, even more preferably an edge of the support plate 110 that is configured to rest in proximity to the casing 108 left side wall 112. Further, the flange 158 generally extends in opposition to the plate 110 top face 154 so that the flange 158 is readily adapted to be disposed in the aperture 124 when the plate 110 is associated with the casing 108.

The support plate 110 is preferably physically configured so as to flushly associate with the casing 108. In that regard and with best reference to FIGS. 3 and 6, the support plate 110 is preferably configured to generally rest within the casing 108 inner cavity 122. More specifically, the support plate 110 is preferably dimensioned so as to fit within the casing 108 walls 112, 114, 116, 118, and rest atop the support bosses 150, 152 and the shoulder 148, thereby positioning the plate 110 top face 154 at a level generally coterminal with the top edges of the walls 112, 114, 116, 118, as evident in FIG. 3.

Further thereto, the support plate 110 is preferably also configured to fit within the contours as defined by the casing 108 corner portions 144. As best shown in FIGS. 7 and 8, the corner portions 144 are preferably generally square in cross sectional shape, one corner of which is disposed in the inner cavity 122 (while the other corners are generally flush with the casing 108). As shown in FIGS. 7 and 8, the exposed corners of the corner portions 144 are preferably generally curved and/or radiused along their vertical faces. Accordingly, the plate 110 is preferably configured along its corners to fit within the casing 108 corner portions 144. As best shown in FIG. 6, the plate 110 generally features corners 160 that are complementary to the casing 108 corner portions 144 (i.e., the plate 110 corners 160 are generally inwardly cutout portions featuring an arcuate face). Therefore, when the plate 110 is associated with the casing 108, the plate 110 corners 160 generally receive the casing 108 corner portions 144 thereagainst.

As previously mentioned, the support plate 110 is suitably adapted to releasably engage the casing 108, and thereby complete the housing 101. As also previously mentioned, the casing 108 preferably includes at least one support boss 150, 152 having the bore therethrough that is adapted to secure the fastener 155 (e.g., a screw, a rivet, and the like) thereto. In that regard, the support plate 110 preferably includes at least one bore 166, 168 that enables communication between the plate 110 top face 154 and bottom face 156. The bore 166, 168 is suitably positioned so as to enable ready communication with the support boss 150, 152 bore when the plate 110 is positioned on the casing 108. Accordingly, when the plate 110 is so positioned, the fastener 155 may suitably be passed through the plate bore 166, 168 and into engagement with the casing 108 support boss 150, 152 bore, thereby releasably securing the plate 110 to the casing 108.

As will be more fully explained hereinafter, the customer interface 104 preferably includes a customer lock mechanism 178 that, in turn, includes a lock cylinder. As will also be more fully explained, the customer interface 104 may suitably also include a guard lock mechanism 182 that, in turn, also includes a lock cylinder. As known, the customer interface 104, particularly the lock mechanism(s) 178, 182 thereof, should be disposed for communication with an environment external to the safe deposit box, generally so that customers may interact with the interface 104 for selectably opening and closing the safe deposit box door 102. As also previously mentioned, the lock assembly 100 housing 101 is preferably configured to abuttingly rest against a rear face of the safe deposit box door 102. Accordingly, the housing 101 support plate 110 is preferably configured to permit the customer interface 104, and various components thereof (e.g., the customer lock mechanism 178, the guard lock mechanism 182, etc.) to extend therethrough, as shown in FIG. 6.

With continued reference to FIG. 6, the plate 110 preferably includes an aperture 162 therein that permits the customer lock mechanism 178 to extend through the plate 110. The aperture 162 is preferably generally circular in configuration to accommodate the configuration of the customer lock mechanism 178, as will be more fully described hereinafter.

In connection with an embodiment in which the customer interface 104 includes the guard lock mechanism 182, the support plate 110 may include another aperture 164 that permits the guard lock mechanism 182 to extend through the plate 110. The aperture 164 is also preferably generally circular in configuration to accommodate the configuration of the guard lock mechanism 182, as will be more fully described hereinafter.

As previously mentioned, the support plate 110 includes various structure that enables association between the plate 110 and the customer interface 104. With continued reference to FIG. 6, the support plate 110 preferably includes a first shoulder 170a and a second shoulder 170b disposed in proximity to the aperture 162 and which are adapted to enable customer interface 104 association. Each shoulder 170a, 170b is preferably provided as a substantially rectangular member disposed and extending generally perpendicular to the support plate 110 bottom face 156. Even more preferably, the shoulders 170a, 170b are preferably disposed opposite each other relative to the aperture 162 (e.g., the shoulders 170a, 170b are preferably positioned diametrically opposite each other at approximately 0 degrees and 180 degrees, respectively, about the aperture 162). In this configuration, the shoulders 170a, 170b are disposed so as to abut opposite portions of the customer interface 104, even more preferably the customer lock mechanism 178 thereof.

The shoulders 170a, 170b may suitably each also include a bore 172a, 172b extending therethrough. As will be more fully explained hereinafter, the customer lock mechanism 178 may suitably also include one or more bores therethrough. Accordingly, the customer lock mechanism 178 may suitably be secured to the support plate 110 by disposition of one or more fasteners (e.g., screw, set screw, etc.) through the shoulder 170a, 170b bores 172a, 172b and lock mechanism 178, as will be more fully described hereinafter.

The guard lock mechanism 182, if optionally present, may be secured to the support plate 110 through a similar mechanism. With continued reference to FIG. 6, the support plate 110 may suitably include a first shoulder 174a and a second shoulder 174b disposed in proximity to the aperture 164 and which are adapted to enable customer interface 104 association. Each shoulder 174a, 174b is preferably provided as a substantially rectangular member disposed and extending generally perpendicular to the support plate 110 bottom face 156. Even more preferably, the shoulders 174a, 174b are preferably disposed opposite each other relative to the aperture 164 (e.g., the shoulders 174a, 174b are preferably positioned diametrically opposite each other at approximately 0 degrees and 180 degrees, respectively, about the aperture 164). In this configuration, the shoulders 174a, 174b are disposed so as to abut opposite portions of the customer interface 104, even more preferably the guard lock mechanism 182 thereof.

The shoulders 174a, 174b may suitably each also include a bore 176a, 176b extending therethrough. As will be more fully explained hereinafter, the guard lock mechanism 182 may suitably also include one or more bores therethrough. Accordingly, the guard lock mechanism 182 may suitably be secured to the support plate 110 by disposition of one or more fasteners (e.g., screw, set screw, etc.) through the shoulder 174a, 174b bores 176a, 176b and lock mechanism 178, as will be more fully described hereinafter.

Turning now to a discussion of the customer interface 104, the customer interface 104 suitably provides a means by which a customer or other individual to whom a safe deposit box is assigned selectably gains and/or prevents access to the contents of the safe deposit box to which the lock assembly 100 is associated. In a preferred embodiment, the customer interface 104 generally operates, at least in general principle, in a lock and key manner according to which a customer-issued key may suitably actuate the lock for alternation between an open and a closed configuration.

In a preferred, yet exemplary, embodiment, the customer interface 104 suitably includes a customer lock mechanism 178 and a guard lock mechanism 182, as earlier mentioned. In general, the customer lock mechanism 178 provides an interface between a customer to whom the safe deposit box is assigned and the lock assembly 100 (e.g., the customer lock mechanism 178 is preferably adapted to receive a customer-issued key and translate key-based actuation into lock mechanism 178 actuation). Also in general, the guard lock mechanism 182, if optionally present, provides an interface between a guard (e.g., a bank official or other individual charged with administering and generally overseeing access to a collection of safe deposit boxes). Such guard lock mechanism 182 interface may suitably be employed to provide an additional level of access restriction (e.g., actuation of the guard lock mechanism 182 may suitably be required before the customer lock mechanism 178 may be actuated by the customer-issued lock), as will be more fully explained hereinafter.

Turning now to a discussion of the customer lock mechanism 178 and with best reference to FIGS. 3, 5 and 8, the customer lock mechanism 178 is preferably defined by a customer lock 179, and a gear 180 operably associated therewith. The customer lock 179 is preferably provided as a pin tumbler-style lock capable of receiving a key and translating rotation of the key into a lock 179 actuation. The gear 180 is preferably associated with a rear portion of the customer lock 179 and is preferably rotated in response to actuation of the customer lock 179. As will be more fully explained hereinafter, the gear 180 is preferably operably associated with the locking mechanism 106; accordingly actuation of the customer lock 179 suitably translates into actuation of the locking mechanism 106 by operable intervention of the gear 180.

In a preferred embodiment, the customer lock 179 is provided as a pin tumbler-style lock. Reference will be made throughout to such a preferred style lock. However, it is to be appreciated that any suitable style of lock may be employed to accomplish the aims of the present invention.

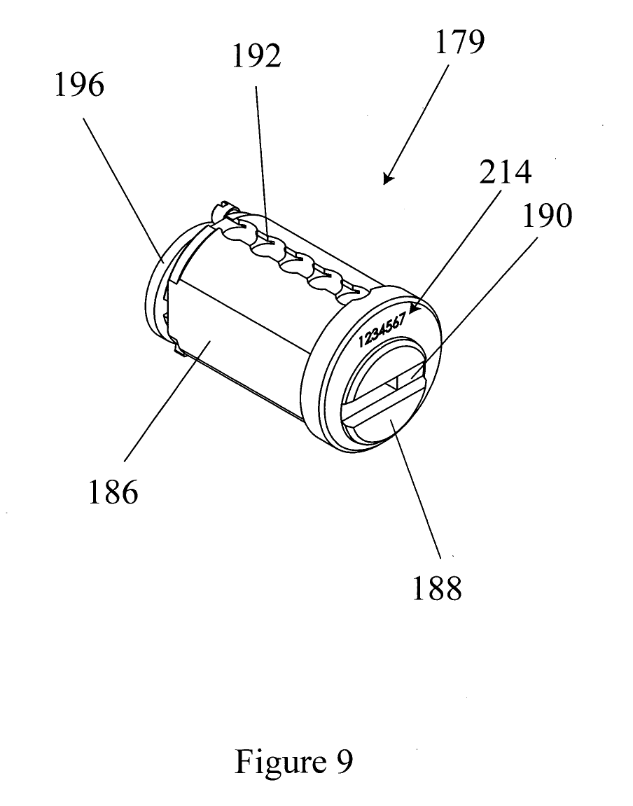

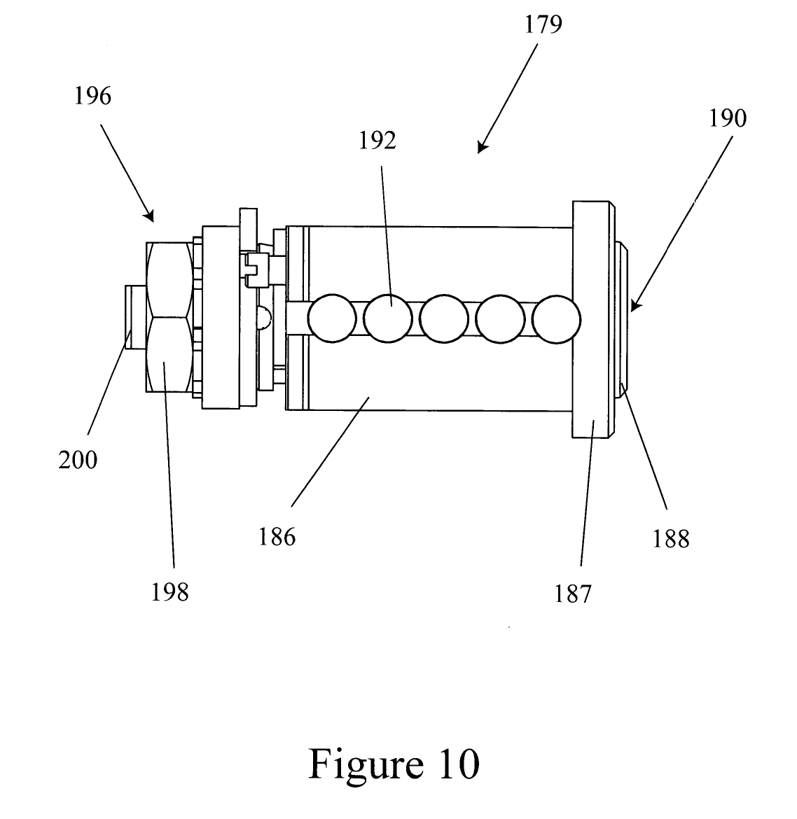

With best reference to FIGS. 9 and 10, the customer lock 179 generally includes a cylinder case 186, a plug 188, a keyway 190, an upper pin chamber 192, a lower pin chamber, springs, drivers, bottom pins and a tail piece 196. The cylinder case 186 is generally provided as a substantially cylindrical member adapted to house the various additional customer lock 179 components, and which is also adapted to be disposed within the support plate 110 aperture 162, as previously described.

As also previously mentioned, the customer lock 179, as a component of the customer interface 104, preferably includes various structure that permits an assigned customer to engage the customer interface 104 when the safe deposit box door 102 is in a closed configuration. Accordingly, the customer interface 104 suitably includes structure that is accessible from the outside of the safe deposit box door 102. In that regard, the customer lock 179 preferably includes a terminal face having dimensions relatively larger than the dimensions of the cylinder case 186. As will be more fully explained hereinafter, the door 102 suitably includes an aperture similar to the plate 110 aperture 162 through which the customer lock 179 is generally disposed. Therefore, dimensioning the customer lock 179 face as a member relatively larger than the cylinder case 186 suitably provides a means for securely disposing a portion of the customer interface 104 outside the safe deposit box door.

The customer lock 179 suitably also includes the plug 188 that is generally disposed, at least partially, within the cylinder case 186, and secured relative thereto by a retainer ring or similar feature. The plug 188 is preferably also a substantially cylindrical member that is adapted to rotate within the cylinder case 186. More specifically, the plug 188 suitably includes the keyway 190 disposed along a front portion thereof, optionally paracentric relative thereto, that permits a key or similar unlocking means to be inserted into the plug 188. The plug 188, either alone or in combination with various additional elements, is configured to feature the actuation configuration, as previously mentioned. Accordingly, and in operation, a customer positions in the keyway 190 and then pushes the key inward so as to occupy the plug 188. If the profile of the customer key matches the actuation configuration of the plug 188, the customer rotates the key, thereby rotating the plug 188 actuating the customer interface 104.

As previously mentioned, the customer interface 104, particularly the customer lock 179 thereof, is adapted to feature any of a wide range, preferably over one million, actuation configurations. The practical import of this feature is that the customer interface 104 of the present invention is generally actuable only by a key or similar unlocking means featuring a very specific profile. Because of the number of possible actuation configurations possible for the customer lock 179, there exists a statistically significant very low probability that an otherwise unauthorized customer and/or key may actuate a given safe deposit box lock assembly 100. Such very low probability suitably provides a level of security heretofore unattained in safe deposit box practice.

The customer interface 104, particularly the customer lock 179, preferably includes certain features that enable it to adopt any of the wide range of actuation configurations. In a preferred embodiment, such features are generally provided by cooperation of the customer lock 179 upper pin chamber 192, lower pin chamber, springs, drivers and bottom pins. The upper pin chambers 192 are preferably provided as bore-like features cylindrically extending transversely through the plug 188; as such, the upper pin chambers 192 generally communicate between an outer face of the cylinder case 186 and an inner face thereof (which inner face generally abuts the plug 188 when the plug 188 is disposed therein). The lower pin chambers (not visible in the drawings) are substantially similar to the upper pin chambers 192, with the exception that the lower pin chambers are generally disposed transversely within the plug 188. More specifically, the lower pin chambers generally communicate between an outer face of the plug 188 (i.e., the face that abuts the inner face of the cylinder case 186), and an inner portion of the plug 188. Such inner portion of the plug generally communicates with the keyway and is configured to define the actuation configuration.

The upper pin chambers 192 and the lower pin chambers are generally adapted to house springs, drivers and bottom pins therein. In a preferred embodiment, the upper pin chambers 192 generally each feature a spring disposed therein. A first end of the spring preferably abuts an upper portion of the upper pin chamber 192 so as to provide a substrate against which the spring may generate spring force. A second end of the spring is preferably disposed downward into the upper pin chamber 192 and is adapted to communicate with a top pin-like driver. The driver is a generally cylindrical member adapted to be vertically translated through the upper and low pin chambers by action of the spring. The driver includes a top face that remains in general abutting contact with the spring, and a lower face that remains in general abutting contact with a bottom pin. The bottom pin is generally disposed within the plug 188 lower pin chamber and includes a top face that remains in contact with the driver, and a lower face that extends into the plug 188, particularly a portion thereof that defines the lock 179 actuation configuration. As will be more fully explained, the bottom pin lower face is preferably adapted to cooperate with the other bottom pins and the plug 188 to define the actuation configuration that a key must match to permit lock 179 actuation.

In general operational terms, when a key is not inserted into the cylinder case 186, the downward pressure of the springs drives the drivers partially downward into the plug 188 to prevent the plug 188 from being rotated (and thereby preventing actuation of the lock 179). In this configuration, the drivers generally occupy a shear line of the lock 179. The shear line is generally defined by the interface of the plug 188 and the cylinder case 186. Accordingly, the presence of the drivers along the shear line provides a physical impediment to the free rotation of the plug 188, thereby securing the lock 179 in a locked configuration. When a key featuring a proper actuation configuration profile is inserted into the keyway 190 and plug 188, the pins and drivers vertically translate within the upper and lower pin chambers. More specifically, the correct key suitably causes the top face of the bottom pin and the bottom face of the driver to meet at the shear line. In this configuration, the physical impediment to plug 188 rotation is removed and the lock 179 may suitably be actuated by rotation of the key disposed therein.

The customer lock 179 may suitably permit any of the many, preferably more than one million, actuation configurations, through any of a number of aspects, either alone or in various combination. In one aspect, the customer lock 179 may feature any suitable number of pin chambers and associated components (e.g., upper pin chamber, lower pin chamber, spring, driver, bottom pin, etc.). The customer lock 179 may feature approximately 2-12 pin chambers, more preferably approximately 4-11 pin chambers, even more preferably approximately 7-10 pin chambers.

In another aspect, the drivers and the bottom pins may be provided in any suitable configuration that increases the range of actuation configurations adoptable by the customer lock 179. For example, the driver may be provided in a generally broken profile (e.g., generally dumbbell-like in cross sectional configuration) that causes the driver to hang up before it crosses the shear line. Any other suitable examples may be employed in connection with the present invention.

In a preferred embodiment, the customer lock 179 is provided as a high security element. More specifically, the customer lock 179 is preferably provided as a locking mechanism that features resistance against picking, impressioning, drilling, wrenching and other common forms of burglary. Even more preferably, the customer lock 179 is provided as a locking mechanism that meets Underwriters Laboratories, Inc. (UL) standard 437. Further thereto, the preferred locking mechanism, including its working parts, is constructed of a durable material, such as brass, bronze, stainless steel or similar corrosion-resistant material.

Returning to a general discussion of the customer lock 179, the lock 179 suitably also includes the tailpiece 196, as best shown in FIGS. 9 and 10. The tailpiece 196 is preferably operably associated with the customer lock 179, preferably the plug 188 thereof, so that rotation of the plug 188 is translated into actuation of the tailpiece 196. As will be more fully explained hereinafter, the tailpiece 196 is preferably operably associated with the locking mechanism 106. Accordingly, actuation of the tailpiece 196 suitably translates into actuation of the locking mechanism 106, thereby enabling selective locking and opening of the lock assembly 108.

With best reference to FIG. 6, the tailpiece 196 is generally defined by a base portion 198, a projecting portion 200, and a cylindrical recess 202. As will be more fully hereinafter, the base portion 198 is preferably an element of the customer lock 179 that is operably associated with the gear 180 (i.e., the base portion 198 preferably enables actuation of the customer lock 179 to be translated to the gear 180). In a preferred embodiment, the base portion 198 is generally defined by a pair of opposed side faces that are preferably coplanar relative to each other, and further which extend generally coaxially to the longitudinal axis of the customer lock 179. Thus, the base portion 198 is generally rectangular in cross sectional profile, and may suitably also feature arcuate faces as the front and rear faces thereof.

The tailpiece 196 preferably also includes the projecting portion 200 that generally extends from the base portion 198 away from the customer lock 179. The projecting portion 200 is preferably provided as a generally cylindrical member, optionally featuring opposed and generally planar side faces, similar to the planar side faces of the base portion 198. The projecting portion 198 may suitably also includes a generally cylindrical recess 202 disposed therein, an open end of which is generally disposed along a terminal face of the projecting portion 198.

Turning now to FIG. 8, the customer interface 104 suitably also includes the gear 180 that generally provides an operable interface between the customer lock 179 and the locking mechanism 106. In a preferred embodiment, the gear 180 is provided as a generally disc-like member having a plurality of teeth 204 circumferentially disposed thereabout. As will be more fully explained hereinafter, the teeth 204 are preferably adapted to engage complementary structure on the locking mechanism 106 for actuation of the same.

The gear 180 preferably also includes various structure that permits the gear 180 to associate with both the housing 101 and the customer lock 179. As previously mentioned, the housing 101 preferably includes the projection 138 that is provided as a generally cylindrical member extending from the top face 134 of the base wall 120. Accordingly, the gear 180 preferably includes an aperture that permits rotatable engagement between the gear 180 and the projection 138. Even more preferably, the aperture is preferably disposed concentrically within the gear 180 so that rotation of the gear 180 occurs along a continuous axis of rotation.

The gear 180 suitably also includes structure for interfacing with the customer lock 179 tailpiece 196 and accepting rotation thereof. Even more preferably, the gear 180 structure is provided in a shape generally complementary to the preferred tailpiece 196 structure so that a tight fit is achieved between the tailpiece 196 and the gear 180 for smooth and durable operation. With continued reference to FIG. 8, the gear 180 preferably includes a pair of shoulders 206 and a cylindrical portion 208 disposed therebetween. The shoulders 206 are preferably spaced apart from each other about the cylindrical portion 208 (a central portion of which accepts the projection 138), and each preferably include a face. The shoulders' 206 faces are preferably coplanar to each other and generally extend coaxially relative to the longitudinal axis of the customer lock 179. In this configuration, the gear 180 shoulders 206 are preferably adapted to securely receive the tailpiece 196 base portion 198, particularly the side faces thereof, therebetween. Because the tailpiece 196 base portion 198 side faces flushly abut the gear 180 shoulders 206, rotation of the tailpiece 196 (suitably caused by rotation of the plug 188) is securely and repeatably translated to the gear 180.

The gear 180 also preferably includes the cylindrical portion 208 disposed between the shoulder 206. The cylindrical portion 208 generally includes the gear 180 aperture that permits the gear 108 to associate with the housing 101 projection 138. The cylindrical portion 208 is preferably also configured so as to receive the tailpiece 196 projecting portion 200 therein. In that regard, the tailpiece 196 cylindrical recess 202 is generally disposed so as to communicate with the housing 101 projection 138 that extends through the gear 180 aperture and into contact with the tailpiece 196 cylindrical recess 202.

As previously mentioned, the lock assembly 100 preferably also includes the locking mechanism 106 that provides a structure capable of releasably engaging structure on the safe deposit box for locking the safe deposit box thereto. More specifically and with reference to FIG. 1, the locking mechanism 106 is preferably provided as a bolt-like member capable of retraction toward the lock assembly 100 (thereby enabling the safe deposit box door 102 to be opened), and extension away from the lock assembly 100 into engagement with complementary structure on the safe deposit box, which engagement suitably prevents the door 102 from being opened, absent actuation by the proper customer-issued key.

Turning now to FIG. 8, the locking mechanism 106 is preferably provided as a generally planar member having a base portion 224 and a bolt portion 226. The base portion 224 is preferably provided as a generally rectangular member having a top edge 244, a bottom edge 246, a left edge 248 and a right edge 250. The top edge 244 is preferably disposed in general proximity to the casing 108 rear wall 116; the bottom edge 246 is preferably disposed in general proximity to the casing 108 front wall 118; the left edge 248 is preferably disposed in general proximity to the casing 108 left side wall 112; and the right edge 250 is preferably disposed in general proximity to the casing 108 right side wall 114.

The locking mechanism 106 base portion 224 top edge 244 is preferably provided as a generally linear feature adapted to remain in general proximity to the casing 108 rear wall 116. In an embodiment in which the casing 108 includes the support boss 150, the top edge 244 may suitably include a partially cut away portion to permit the base portion 224 to slide unimpeded relative to the support boss 150.

The locking mechanism 106 base portion 224 bottom edge 246 is preferably adapted to remain in general proximity to the casing 108 front wall 118. Even more preferably, the customer interface 104, particularly the customer lock 179 thereof, is disposed between the locking mechanism 106 base portion 224 and the casing 108 front wall 118. Accordingly, the bottom edge 246 generally provides a ready site for interface between the gear 180 and the locking mechanism 106. As previously mentioned, the gear 180 preferably includes a plurality of teeth 204 disposed circumferentially thereabout. Further thereto, the locking mechanism 106 bottom edge 246 preferably includes a plurality of corresponding teeth 252 that are adapted to engage the gear 180 teeth 204. In a preferred embodiment, the bottom edge 246 teeth 252 are preferably arranged seriatim and/or generally linearly therealong. Accordingly, rotation of the gear 180 suitably causes translation of the locking mechanism 106 along a linear path.

The locking mechanism 106 base portion 224 left edge 248 suitably terminates into the bolt portion 226. Various aspects of the bolt portion 226 will be more fully described hereinafter.

The locking mechanism 106 base portion 224 right edge 250 is preferably adapted to remain in general proximity to the casing 108 right side wall 114. In general, the right edge 250 is provided as a generally linear face disposed generally perpendicularly to the casing 108 front and rear walls 116, 118, respectively. As will be more fully explained hereinafter, the customer interface 104 of the present invention may suitably also include the guard lock mechanism 182, which mechanism 182 may suitably include a rotatable cam-like member that is adapted to interface with the locking mechanism 106. In this embodiment, the guard lock mechanism 182 cam may suitably interface with the locking mechanism 106 right edge 250, as will be more fully explained hereinafter.

The locking mechanism 106 base portion 224 may suitably include various structure that enables it to engage the housing 101. As previously mentioned, the locking mechanism 106 is preferably slidably disposed within the housing 101. Accordingly, the housing 101 structure that engages the locking mechanism 106 is preferably provided as any structure that enables such slidable association. With continued reference to FIGS. 7 and 8, the locking mechanism 106 base portion 224 may suitably include a channel 254 that extends within the base portion 224, and generally coaxially with the longitudinal axis thereof. As also previously mentioned, the casing 108 preferably includes one or more projections 142 that extend from the casing 108 base wall 120. Accordingly, the base portion 224 channel 254 is preferably adapted to receive the casing 108 projections 142 therethrough and slide relative thereto.

Turning now to a discussion of the locking mechanism 106 bolt portion 226 and with continued reference to FIGS. 7 and 8, the bolt portion 226 generally provides an operable element of the locking mechanism 106 that is capable of selectably engaging the safe deposit box. The bolt portion 226 is preferably provided as a generally rectangular member extending from the locking mechanism 106 base portion 224 left edge 248. In this configuration, the bolt portion 226 is generally configured to extend through the housing 101 aperture 124 (FIG. 7) for engagement with the safe deposit box, and to retract through the housing 101 aperture 124 for selective safe deposit box door 102 opening.

Turning now to a continued discussion of the customer interface 104, the customer interface 104 may suitably also include the guard lock mechanism 182. Under certain circumstances, it may be desirable to provide a dual means for restricting access to the contents of a safe deposit box. In such a dual means system, the first means is preferably provided by the customer lock 179 that requires a customer to actuate the customer lock 179 with the customer-issued key. The second means may suitably be provided by the guard lock mechanism 182 that also must be actuated by a corresponding guard key before the lock assembly 100 may be actuated. Such a guard key may suitably be maintained by an authorized individual (e.g., an employee of the institution in which the collection of safe deposit boxes is housed) who must first actuate the guard lock mechanism 182 before the customer lock 179 may be actuated. The use of such a dual means system provides an additional level of security by requiring an institutional authorized individual to first permit the customer to access the customer safe deposit box. It is to be appreciated, however, that the guard lock mechanism 182 is an optional element of the lock assembly 100, and may suitably be omitted therefrom.

The guard lock mechanism 182, if optionally present, may be provided as any element capable of accomplishing the aims of the present invention. In a preferred embodiment, the guard lock mechanism 182 generally includes a conventional pin-style tumbler guard lock 210 and an associated cam 184. The guard lock 210 may be provided as any suitable lock capable of accepting a key and translating key-based actuation into cam 184 actuation. The guard lock 210 may be a high security lock, a standard security lock, or any other style of lock. Accordingly, it is to be appreciated that the foregoing discussion of the customer lock 179 is generally applicable to the guard lock 210, and that the guard lock 210 may feature one or more of the elements of the customer lock 179 (e.g., cylinder case, plug, keyway, upper pin chambers, lower pin chambers, etc.).

Similar to the customer lock 179, the guard lock 210 preferably includes a face 212 that is provided in relatively larger dimensions than the cylinder case thereof. Also similar to the customer lock 179, the guard lock 210, as a component of the customer interface 104, preferably includes various structure that permits an authorized individual to engage the guard lock mechanism 182 when the safe deposit box door 102 is in a closed configuration. Accordingly, the customer interface 104 suitably includes structure that is accessible from the outside of the safe deposit box door 102. In that regard, the guard lock 210 preferably includes a terminal face having dimensions relatively larger than the dimensions of its cylinder case. As previously described, the door 102 suitably includes an aperture similar to the plate 110 aperture 164 through which the guard lock 210 is generally disposed. Therefore, dimensioning the guard lock 210 face 212 as a member relatively larger than the cylinder case suitably provides a means for securely disposing a portion of the guard lock 210 outside the safe deposit box door for ready access.

Turning now to FIG. 6, the guard lock 210 preferably includes a tailpiece 220 that is operably associated with the guard lock 210 plug, in a manner generally similar to the customer lock 179 and its tailpiece 220. In a preferred embodiment, the tailpiece 220 is provided as a substantially square member having a relatively low vertical profile. As will be more fully explained hereinafter, the preferred square configuration of the tailpiece 220 is generally adapted to interface with complementary structure of the cam 184. Also similar to the customer lock 179 tailpiece 220, the guard lock 210 tailpiece 220 preferably also includes a cylindrical recess 222 for engaging the casing 108 projection 140, as will be more fully described.

Turning now to FIG. 7, the guard lock mechanism 182, if optionally present, may suitably also include the cam 184. As previously mentioned, the cam 184 may suitably function in connection with a dual access restriction approach for the lock assembly 100. More specifically, the cam 184 preferably operates in conjunction with the guard lock 210 to restrict actuation of the locking mechanism 106. In that regard, the cam 184 is preferably adapted to alternate between an open and/or on configuration (FIG. 8) and a closed and/or off configuration (FIG. 7). In the open configuration, the cam 184 is rotated away from the locking mechanism 106, particularly the base portion 224 thereof, thereby permitting the locking mechanism 106 to withdraw into the housing 101 and enabling the door 102 to be opened. In the closed configuration, the cam 184 is rotated toward the locking mechanism 106 and generally rests in abutting contact with the base portion 224 right edge 250. In this embodiment, the cam 184 is not able to freely rotate because of its association with the guard lock 210. Accordingly, when the cam 184 is in the closed configuration, the locking mechanism 106 is prevented from withdrawing into the housing 101, thereby preventing the safe deposit box door 102 from being opened.

Certain advantages may be realized by configuring the customer interface 104 to include both the customer lock mechanism 178 and the guard lock mechanism 182. As previously mentioned, a, conventional safe deposit box lock typically incorporates both a customer lock mechanism and a guard lock mechanism. However, actuation of the safe deposit box requires simultaneous actuation of both the customer lock mechanism and the guard lock mechanism. More specifically, both lock mechanisms must have a corresponding key inserted therein, and both keys must be turned at the same time to actuate the lock. As evident, this conventional approach produces undesirable results. For example, an official, such as a bank employee, a hotel employee, etc., must be present for a customer to gain access to his/her safe deposit box, thereby preventing customers from self serving their access needs.

The lock assembly 100 of the present invention, especially in connection with the customer lock mechanism 178 and guard lock mechanism 182 embodiment, suitably overcomes the simultaneous actuation limitation of conventional safe deposit box locks. The inclusion of the guard lock mechanism 182 suitably enables the lock assembly 100 to be disposed in either an “on” configuration or an “off” configuration. As previously mentioned, the customer lock mechanism 178 and the guard lock mechanism 182 are preferably independently actuable. As also previously mentioned, if the guard lock mechanism 182 is present, it must be actuated before the lock assembly 100 can be opened. Accordingly, the guard lock mechanism 182 may suitably be independently actuated to dispose the lock assembly 100 in either the on or off configuration.

In connection with a preferred embodiment, the configuration of the guard lock mechanism 182 determines whether the lock assembly 100 is in the off configuration or the on configuration. For example, if the guard lock mechanism 182 is locked (i.e., its cam 184 is disposed against the locking mechanism 106 and thereby prevents movement thereof), the lock assembly 100 is in the off configuration, thereby preventing actuation of the lock assembly 100 absent actuation of the guard lock mechanism 182. By way of continued example, if the guard lock mechanism 182 is unlocked (i.e., its cam 184 is rotated away from the locking mechanism 106, thereby enabling movement thereof), the lock assembly 100 is in the on configuration. When the lock assembly 100 is in the on configuration, customer self service is possible, i.e., a customer may actuate the lock assembly 100 and gain access to the contents of the safe deposit box without the continued assistance of an official.

The ability to turn the lock assembly 100 either on or off may present certain advantages. As previously mentioned, customer self service is possible, thereby eliminating the need for a, e.g., bank official to monitor a customer's usage. However, the continued ability to turn the lock assembly 100 on or off eliminates complications inherent in such self service. Thus, for example, if a customer has failed to satisfy financial obligations associated with use of a safe deposit box, the lock assembly 100 may be disposed in the off configuration for preventing customer access until the obligations are met. By way of additional example, if a customer becomes entangled in a legal action, such as an Internal Revenue Service investigation, the lock assembly 100 may be disposed in the off configuration to comply with a legal mandate.

As previously mentioned, the lock assembly 100 is preferably actuable by a customer issued key having a profile corresponding to the actuation configuration. The key may suitably also contribute to the preferred self service aspects of the lock assembly 100. For example, the key may suitably be provided as a convenience key. A convenience key can operate a lock regardless of the orientation of the key when inserted into the keyway. Conventional keys can typically be inserted into a lock in two orientations, an up orientation and a down orientation, each of which orientations is generally a one hundred and eighty degree rotational inverse of the other. Conventional keys typically require insertion into a lock in only one of the two configurations for actuation to occur. In contrast, convenience keys may suitably actuate a lock regardless of whether the convenience key is inserted into the lock in an up orientation or a down orientation. Thus, the use of a convenience key suitably supports customer self service by reducing the likelihood that a customer will encounter difficulty in actuating the lock assembly 100.

A discussion will now be presented illustrating an example method by which the lock assembly 100 may suitably be associated with a safe deposit box door 102. In a preferred embodiment, the customer lock 179, preferably as an item not associated with the remainder of the lock assembly 100, is preferably inserted into the door 102 aperture 162. The guard lock 210, if optionally present, may suitably also be inserted in a similar manner through the door 102 aperture 164. Thereafter, the housing 101 (here generally constituted by the casing 108, the support plate 110, the gear 180, the locking mechanism 106, and, optionally, the cam 184), preferably along its support plate 110, is brought into abutting contact with a rear face of the door 102. As the housing 101 is brought into such contact, rear portions of the customer lock 179 and, optionally, the guard lock 210 enter the housing 101 inner cavity 122, thereby bringing the tailpieces 196, 220 into communicable association with the gear 180 and cam 184.

As previously mentioned, the lock assembly 100 of the present invention preferably also includes means for securing the customer lock 179 and, optionally, the guard lock 210 to the housing 101. As also previously mentioned, the support plate 110 preferably includes a first pair of shoulders 170a, 170b and a second pair of shoulder 174a, 174b. Each pair of shoulders 170a, 170b, 174a, 174b preferably provides a substrate against which the customer lock 179 and the guard lock 210 may suitably be secured. The shoulders 170a, 170b, 174a, 174b preferably each also include the bores 172a, 172b, 176a, 176b that permit a fastener, such as a set screw, to be disposed within the bores 172a, 172b, 176a, 176b and engage complementary receiving structure on the customer lock 179 and guard lock 210. Thus, in operation, once the rear portions of the customer lock 179 and the guard lock 210 have been brought into the housing 101 inner cavity 122, the set screw-like fastener is preferably tightened, thereby anchoring the customer lock 179 and, optionally, guard lock 210 relative to the housing 101. The casing 108 arcuate portions 128, 130 generally provide a means for accessing the fasteners with, e.g., an allen wrench or similar means.

Thus, because of the ease of installation of the lock assembly 100 of the present invention, it is to be appreciated that the lock assembly 100 may suitably be associated with any convention safe deposit box door 102. Even more advantageously, such a conventional safe deposit box door 102 may have its existing lock assembly removed and replaced by the lock assembly 100 of the present invention, thereby ensuring a relatively seamless transition.

The lock assembly 100 of the present invention may suitably interface with other elements to increase the level of security afforded thereby. In connection with a preferred embodiment, the lock assembly 100 actual lock mechanism(s) (e.g., the customer lock mechanism 178, the guard lock mechanism 182, etc.) may be selected on the basis proprietary technology. For example, there are several commercially available lock mechanisms that are actuable only by a proprietary key. Such a proprietary key is typically subject to one or more patents that protect various aspects, such as the physical configuration of the key (e.g., key blank features, key blade features, key shoulder features, etc.), various means by which such a key is machined, etc. Accordingly, such keys are non-duplicable and are only produced in accordance with strict guidelines. Examples of lock systems subject to proprietary aspects include, by way of non-limiting example, U.S. Pat. No. 6,477,875 to Field et al, U.S. Pat. No. 5,176,015 to Sussina, and U.S. Pat. No. 5,520,035 to Eizen et al., the contents of all of which are hereby incorporated by reference in their entireties.

As previously mentioned, the ability of the lock assembly 100 to adopt any one of many different actuation configurations renders it highly unlikely that a given collection of safe deposit boxes would feature two lock assemblies 100 having the same actuation configuration. However, various additional measures may be employed to completely eliminate the possibility that a collection features two identically keyed lock assemblies 100, as will be more fully explained.

An example system that eliminates the possibility of repeating lock assemblies 100 within a given collection of safe deposit boxes will now be discussed. Once a lock has been identified for use as the lock assembly 100 customer lock 179, every potential actuation configuration therefor may suitably be predicted. More specifically, once the lock has been identified and its components understood (e.g., the number of pin chambers, etc.), a systematic approach may be undertaken to predict every potential actuation configuration that the lock can adopt in a preferred embodiment, a data processing device (e.g., a computer) executing an appropriate set of instructions is employed to predict the potential actuation configurations.

Once all possible actuation configurations have been predicted, a database is preferably assembled that lists each configuration and all relevant information therefor. The relevant information preferably includes such information as the actual actuation configuration, the profile that a key must feature to actuate the actuation configuration, and the like. Further, each database entry (with each entry generally corresponding to a discrete actuation configuration) is preferably assigned a unique identification, such as a serial number. The serial number preferably enables ready identification of the actuation configuration and the key profile therefor.

After the database is assembled, a plurality of lock assemblies 100 may suitably be manufactured, with each featuring a different customer lock 179. More specifically, depending on the number of lock assemblies 100 identified for manufacture, a corresponding number of database entries (i.e., actuation configurations) is selected. The database entry information is used to provide a corresponding number of customer locks 179, with each of the customer locks 179 incorporating a different actuation configuration. Accordingly, because the customer locks 179 are provided in accordance with a different actuation configuration, it is known with certainty that the lock assemblies 100 incorporating the customer locks 179 are each different, and that none will be identically keyed.

The customer locks 179 provided in accordance with the database information may suitably each include information that enables ready identification of which actuation configuration each features. With best reference to FIG. 9, the customer lock 179 may suitably include a written indicium, such as a number 214, associated therewith, which indicium enables ready identification of which actuation configuration the customer lock 179 features. As previously mentioned, the database detailing all possible actuation configurations suitably lists each actuation configuration as a separate entry, and a unique identification is associated with each entry. Similarly, the number 214 associated with the lock 179 preferably corresponds with the unique identification used in the database. Accordingly, the association of the number 214 with the lock 179 enables ready identification of which actuation configurations have been used, thereby avoiding duplication of actuation configurations.

The written indicium, preferably provided as the number 214, may be associated with the customer lock 179 in any suitable manner and in any appropriate location. For example, the number 214 may suitably be laser etched onto the lock 179, printed on a sticker-like decal which is separately associated with the lock 179, or any other suitable means.

In connection with a preferred embodiment, the number 214 is associated with a portion of the lock 179 that is visible when the safe deposit box to which the assembly 100 is associated is in a locked configuration. A preferred portion of the lock is one generally in proximity to the keyway 190, as generally shown in FIG. 9.

The positioning of the number 214 for ready inspection when the safe deposit box door is in a closed configuration may provide certain advantages. As previously mentioned, the assembled database preferably includes information that ties each number 214 to its corresponding actuation configuration. Accordingly, in the event that a customer loses his/her key, a duplicate key can be provided by reading the number 214, identifying the database entry that corresponds to the number 214 and producing a duplicate key in accordance with the information provided in the database entry.

In yet another preferred embodiment, the database listing all actuation configuration and number 214 data is maintained as generally confidential and in a manner inaccessible to individuals associated with a collection of safe deposit boxes incorporating lock assemblies 100 constructed in accordance with the database. For example, the database may suitably be maintained by a manufacturer of the lock assemblies 100, or a suitably party appointed by the manufacturer. In practice, the manufacturer typically provides the lock assemblies 100 to an institution, such as a bank, which institution then installs the lock assemblies 100 in various locations. The institution is preferably not given access to the database, while the manufacturer is also preferably not given access to information identifying the exact location of the lock assemblies 100. Accordingly, a double blind situation is established by which neither the manufacturer (or other database manager) nor the institution has sufficient information available to it to gain access to safe deposit boxes incorporating the lock assemblies 100. Thus, in the event that a customer loses his/her key, an official of the institution suitably informs the manufacturer of the number 214 of the subject lock assembly 100, whereupon the manufacturer first authenticates the request, identifies the actuation configuration through the database, produces a replacement key, and then provides the replacement key to the institution for customer use. This approach suitably overcomes the conventional approach of completely replacing a lock assembly in the event that a customer loses a key.

Although the invention has been described with regard to certain preferred example embodiments, it is to be understood that the present disclosure has been made by way of example only, and that improvements, changes and modifications in the details of construction and the combination and arrangement of parts may be resorted to without departing from the spirit and scope of the invention. Such improvements, changes and modifications within the skill of the art are intended to be covered by the scope of the appended claims.

What is claimed is:

1. A lock assembly for a safe deposit box door, wherein the assembly comprises:
a customer lock mechanism capable of at least five million actuation configurations, and wherein the customer lock mechanism includes a selected one of the actuation configurations; and
a locking mechanism, operatively associated with the customer lock mechanism, adapted for selectably engaging a safe deposit box to which the door is pivotally associated for locking the door relative to the safe deposit box.

2. The lock assembly of claim 1, wherein the customer lock mechanism is capable of at least ten million actuation configurations.

3. The lock assembly of claim 2, wherein the customer lock mechanism is capable of at least fifteen million actuation configurations.

4. The lock assembly of claim 3, wherein the customer lock mechanism is capable of at least twenty million actuation configurations.

5. The lock assembly of claim 1, wherein the customer lock mechanism further comprises a gear operatively associated therewith, and wherein actuation of the customer lock mechanism translates into rotation of the gear.

6. The lock assembly of claim 5, wherein the gear is operatively associated with the locking mechanism, whereby actuation of the customer lock mechanism translates into actuation of the locking mechanism.

7. The lock assembly of claim 1 further comprising a guard lock mechanism.

8. The lock assembly of claim 7, wherein the guard lock mechanism comprises a cam operatively associated therewith, wherein actuation of the guard lock mechanism translates into rotation of the cam.

9. The lock assembly of claim 8, wherein the guard lock mechanism cam is operatively associable with the locking mechanism.

10. The lock assembly of claim 9, wherein the guard lock mechanism cam is alternatable between an on configuration, in which the cam is operatively associated with the locking mechanism and thereby prevents actuation of the locking mechanism, and an off configuration, in which the cam is not associated with the locking mechanism and thereby does not prevent actuation of the locking mechanism.

11. The lock assembly of claim 1, wherein the customer lock mechanism further comprises a numerical identification associated therewith, which numerical identification enables identification of the customer lock mechanism's actuation configuration.

12. The lock assembly of claim 1, wherein the customer lock mechanism is adapted to be actuated by a convenience key.

13. The lock assembly of claim 1, wherein the customer lock mechanism is resistant to picking and drilling.

14. The lock assembly of claim 1, wherein the locking mechanism is a bolt mechanism.

15. The lock assembly of claim 1, wherein the locking mechanism is a cam mechanism.

16. A safe deposit box for securely storing articles therein, wherein the box comprises:
a housing adapted for receiving articles into an inner cavity thereof;
a door pivotally associated with the housing; and
a lock assembly associated with the door and adapted for selectably locking the door relative to the housing, wherein the lock assembly comprises:
a customer lock mechanism capable of at least five million actuation configurations, and wherein the customer lock mechanism includes a selected one of the actuation configurations; and
a locking mechanism, operatively associated with the customer lock mechanism, adapted for selectably engaging the housing.

17. The safe deposit box of claim 16, wherein the customer lock mechanism is capable of at least ten million actuation configurations.

18. The safe deposit box of claim 17, wherein the customer lock mechanism is capable of at least fifteen million actuation configurations.

19. The safe deposit box of claim 18, wherein the customer lock mechanism is capable of at least twenty million actuation configurations.

20. The safe deposit box of claim 16, wherein the customer lock mechanism further comprises a gear operatively associated therewith, and wherein actuation of the customer lock mechanism translates into rotation of the gear.

21. The safe deposit box of claim 20, wherein the gear is operatively associated with the locking mechanism, whereby actuation of the customer lock mechanism translates into actuation of the locking mechanism.

22. The safe deposit box of claim 16, wherein the lock assembly further comprises a guard lock mechanism.

23. The safe deposit box of claim 22, wherein the guard lock mechanism comprises a cam operatively associated therewith, wherein actuation of the guard lock mechanism translates into rotation of the cam.

24. The safe deposit box of claim 23, wherein the guard lock mechanism cam is operatively associable with the locking mechanism.

25. The safe deposit box of claim 24, wherein the guard lock mechanism cam is alternatable between an on configuration, in which the cam is operatively associated with the locking mechanism and thereby prevents actuation of the locking mechanism, and an off configuration, in which the cam is not associated with the locking mechanism and thereby does not prevent actuation of the locking mechanism.

26. The safe deposit box of claim 16, wherein the customer lock mechanism further comprises a numerical identification associated therewith, which numerical identification enables identification of the customer lock mechanism's actuation configuration.

27. The safe deposit box of claim 16, wherein the customer lock mechanism is adapted to be actuated by a convenience key.

28. The safe deposit box of claim 16, wherein the customer lock mechanism is resistant to picking and drilling.

29. The lock assembly of claim 16, wherein the locking mechanism is a bolt mechanism.

30. The lock assembly of claim 16, wherein the locking mechanism is a cam mechanism.

31. A safe deposit box for securely storing articles therein, wherein the box comprises:
a housing adapted for receiving articles into an inner cavity thereof;
a door pivotally associated with the housing; and
a lock assembly associated with the door and adapted for selectably locking the door relative to the housing, wherein the lock assembly comprises:
a customer lock mechanism capable of at least twenty million actuation configurations, and wherein the customer lock mechanism includes a selected one of the actuation configurations;
a locking mechanism, operatively associated with the customer lock mechanism, adapted for selectably engaging the housing; and
a guard lock mechanism.

32. The safe deposit box of claim 31, wherein the guard lock mechanism comprises a cam operatively associated therewith, wherein actuation of the guard lock mechanism translates into rotation of the cam.

33. The safe deposit box of claim 32, wherein the guard lock mechanism cam is operatively associable with the locking mechanism, and wherein the guard lock mechanism cam is alternatable between an on configuration, in which the cam is operatively associated with the locking mechanism and thereby prevents actuation of the locking mechanism, and an off configuration, in which the cam is not associated with the locking mechanism and thereby does not prevent actuation of the locking mechanism.

34. The safe deposit box of claim 31, wherein the lock assembly further comprises a gear operatively associated with the customer lock mechanism and the locking mechanism, and wherein the gear is adapted to translate actuation of the customer lock mechanism into actuation of the locking mechanism.

35. The safe deposit box of claim 32, wherein the customer lock mechanism further comprises a numerical identification associated therewith, which numerical identification enables identification of the customer lock mechanism's actuation configuration.

36. The safe deposit box of claim 31, wherein the customer lock mechanism is adapted to be actuated by a convenience key.

37. The safe deposit box of claim 31, wherein the customer lock mechanism is resistant to picking and drilling.

38. The lock assembly of claim 31, wherein the locking mechanism is a bolt mechanism.

39. The lock assembly of claim 31, wherein the locking mechanism is a cam mechanism.
